(19) United States
(12) Patent Application Publication
(10) Pub. No.: US 2013/0201264 A1
(43) Pub. Date: Aug. 8, 2013

(54) OIL BASED INKJET PRINTING METHOD AND INK SET

(71) Applicant: RISO KAGAKU CORPORATION, Tokyo (JP)

(72) Inventors: Ami TERAKADO, Tokyo (JP); Sayako Arai, Tokyo (JP)

(73) Assignee: RISO KAGAKU CORPORATION, Tokyo (JP)

(21) Appl. No.: 13/756,770

(22) Filed: Feb. 1, 2013

(30) Foreign Application Priority Data
Feb. 2, 2012 (JP) 2012-020544

(51) Int. Cl. C09D 11/00

(52) U.S. Cl. CPC C09D 11/30
USPC 347/100; 524/568

(57) ABSTRACT

The present invention provides high printing density and inhibits ink stain on rollers inside printing devices or on continuously printed printing paper when printing is performed with an oil-based ink, particularly when printing is performed at a relatively low resolution such as 300×300 dpi with a high-speed line head inkjet printer, by treating a surface of a printing medium with a coating solution comprising at least inorganic particles, a vinyl chloride-based resin emulsion and water to form an ink receiving layer, and performing printing with an oil-based ink on the ink receiving layer. The coating solution is applied in an amount of 2.0-6.0 g/m² as an amount of inorganic particles.

### BACKGROUND OF THE INVENTION

1. Field of the Invention

The present invention relates to an oil-based inkjet printing method which can improve printing density by inhibiting ink permeation into printing media so as to prevent strike through and bleeding and is excellent in drying of ink, and also relates to an ink set and a coating solution used for the printing method.

2. Description of Related Art Including Information Disclosed Under 37 CFR 1.97 and 1.98

The oil-based ink is advantageous in that ink stain hardly occurs inside printing devices or on continuously printed printing paper because coloring materials and solvents easily permeate together into printing paper so that coloring materials hardly remain on the surface of printing paper. Also, the oil-based ink is advantageous in that water resistance is better than the aqueous ink. Moreover, the oil-based ink is advantageous in that the solvent is difficult to volatilize, thereby reducing frequency of cleaning of ink nozzles when used in the inkjet printing. Thus, the oil-based ink is suitable for high-speed printing, particularly high-speed inkjet printing using a line head printer.

On the other hand, the oil-based ink is defective in that coloring materials hardly remain on the surface of printing paper, thereby causing deterioration of quality of printed images due to difficulty in improvement of printing density, increase of strike through of ink, and bleeding of printed dots.

In the high-speed line head inkjet printing system, formation of a sharp image at a low resolution is required, and for this purpose, printed dots are required to be of a perfect circle with a high printing density. Further, it is required that the ink is rapidly absorbed into printing paper immediately after printed so that no ink stain occurs inside printing devices or on continuously printed printing paper in a post-processing step by a finisher device or the like.

As a method for improving quality of printed image in the inkjet printing using an oil-based ink, it has been proposed that printing is performed on an ink receiving layer that is made of a polymer comprising, as a monomer unit, a compound having an aliphatic hydrocarbon group with 8-18 carbon atoms such as alkyl(meth)acrylates, alkylaryl(meth)acrylates, alkyl(meth)acrylamides, alkylaryl(meth)acrylamides, alkylstyrenes and α-olefins (Patent Document 1). This ink receiving layer has an effect of improving image density, ink absorption and image unevenness, but has no effect of inhibiting ink stain on rollers inside printing devices or on continuously printed printing paper.

In addition, as another method, it has been proposed that an ink is printed on an ink receiving layer which comprises not less than 50 mass % of silica having a predetermined average particle diameter, specific surface area and oil absorption (Patent Document 2). This ink receiving layer has an effect of increasing the diameter of printed dots and thereby providing high printing density, but has no effect of inhibiting ink stain on rollers inside printing devices or on continuously printed printing paper.

In order to obtain a higher printing density, it has also been proposed to set up a step for coating printing paper poor in printing density with a coating solution at a site upstream of the printing head in the high-speed inkjet printing device equipped with a line head so as to form an ink receiving layer. When the amount of the coating solution to be applied is great, the capacity of ink absorption of the coated layer is increased, and thus the above-mentioned property is greatly improved, but problems have occurred such that fixation of the coating layer to paper is lowered, texture of printing paper is lost, and cost of printing paper is increased. When the amount of the pre-treatment solution to be applied is lowered in order to avoid the above problems, ink absorbability of inorganic particles themselves must be made appropriate, and otherwise prints which are good in the balance between improvement of printing density and inhibition of ink stain transferred by rollers that have been passed through cannot be obtained. In the high-speed inkjet printing device, the ink receiving layer must be formed in a short time before printing, but if drying of the layer is insufficient, the oil-based ink fails to be absorbed into the ink receiving layer after printing, and thus the ink stain transferred by rollers that have been passed through or bleeding of printing image occurs.

As a method for inhibiting the ink stain transferred by rollers immediately after printing, it has been proposed that ink absorption is accelerated by coating a pre-treatment solution comprising a hydrophobic binder resin, an organic solvent compatible with the binder resin and hydrophilic porous particles for forming an inkjet ink receiving layer (Patent Document 3). Since the organic solvent contained in the pre-treatment solution for forming the inkjet ink receiving layer of this proposal is highly volatile, the ink receiving layer can be formed quickly after applying the pre-treatment solution, but is inappropriate to use in the high-speed inkjet printing device from the viewpoint of odor and safety.

In addition, it has been proposed that the oil-based ink receiving glossy layer which is composed mainly of a vinyl chloride-acrylic copolymer resin is formed in order to enhance printing density and increase ink absorbability (Patent. Document 4). However, this proposal is directed to a solvent ink comprising a highly-volatile organic solvent as a vehicle, but is not directed to an oil-based ink composed mainly of a low-volatile non-polar solvent, and thus the same effect is not produced.

The conventional proposals have been described above, but no proposal has been made for quickly forming an ink receiving layer immediately after a coating solution comprising water as one of the main components is applied onto paper, and then performing printing with an oil-based ink to achieve a high printing density as well as an ink absorption for inhibiting the ink stain transferred from the rolls that have been passed through.
Patent Document 1: JP-A-H11-286166
Patent Document 2: JP-A-2005-96167
Patent Document 3: JP-A-2004-223762
Patent Document 4: JP-A-2010-234677

### BRIEF SUMMARY OF THE INVENTION

The present invention aims at providing an ink receiving layer which has an effect of providing high printing density and inhibiting ink stain on rollers inside printing devices or on continuously printed printing paper when printing is performed with an oil-based ink, particularly performed at a relatively low resolution such as 300×300 dpi with a high-speed line head inkjet printer.

As a result of diligent researches under the above objects, the present inventors have found that high printing density can be obtained and ink stain on rollers inside printing devices or on continuously printed printing paper can be inhibited by treating a surface of a printing medium with a coating solution comprising at least inorganic particles, water and a vinyl chloride-based resin emulsion to form an ink receiving layer, and performing printing on the ink receiving layer using an oil-based ink, and thus have completed the present invention.

That is, according to one aspect of the present invention, there is provided a printing method using an oil-based ink, which comprises applying a coating solution onto a printing medium and then performing printing on the printing medium with an oil-based ink that comprises at least a coloring material and a solvent, in which said coating solution comprises at least inorganic particles, a vinyl chloride-based resin emulsion and water.

According to another aspect of the present invention, there is provided an ink set useful for applying a coating solution onto a printing medium and then performing printing on the printing medium with an oil-based ink, which comprises an oil-based ink comprising at least a coloring material and a solvent, and a coating solution comprising at least inorganic particles, a vinyl chloride-based resin emulsion and water.

According to still another aspect of the present invention, there is provided a coating solution useful for printing with an oil-based ink by applying the coating solution on a printing medium and then performing printing on the printing medium with the oil-based ink, which comprises at least inorganic particles, a vinyl chloride-based resin emulsion and water.

According to the present invention, a vinyl chloride-based resin emulsion is used in a coating solution, the printing medium is surface-treated with a coating solution comprising at least inorganic particles, a vinyl chloride-based resin emulsion and water to form an ink receiving layer, and then an oil-based ink is used to print on the ink receiving layer, and thus the oil-based ink is prevented from permeating into the printing medium and the coloring material is kept to remain on the surface of the printing medium, thereby bleeding of ink is prevented and high printing density is obtained.

### DETAILED DESCRIPTION OF THE INVENTION

Hereinafter, the present invention will be further described in detail.

### 1. Oil-Based Inks

The oil-based ink used in the present invention is composed mainly of a solvent and a coloring material, but may contain other components, if required.

### 1-1. Solvents

The solvent is not particularly limited as long as it functions as an ink solvent, that is, a vehicle, and may be any of volatile or non-volatile solvents. However, in the present invention, the solvent is preferably composed mainly of a non-volatile solvent from the viewpoint of environment. The non-volatile solvent preferably has a boiling point of not less than 200° C. and more preferably not less than 240° C.

Any of non-polar organic solvents and polar organic solvents may be used as a solvent. These solvents can be used alone or in combination of two or more on condition that they form a single phase. In the present invention, a non-polar organic solvent and a polar organic solvent are preferably used in combination, and a solvent is preferably composed of 20-80 mass % of a non-polar solvent and 80-20 mass % of a polar solvent, and more preferably 30-45 mass % of a non-polar solvent and 55-70 mass % of a polar solvent.

### 1-1-1. Non-Polar Solvents

As the non-polar organic solvent, hydrocarbon solvents including naphthenic, paraffinic and isoparaffinic ones can be used. Concrete examples include dodecane and other aliphatic saturated hydrocarbons, “ISOPAR and EXXOL” (both trade names) available from ExxonMobil Corporation, “AF SOLVENTS, NORMAL PARAFFIN H” (both trade names) available from Nippon Oil Corporation, and “SUNSEN and SUNPAR” (both trade names) available from Japan Sun Oil., Ltd. These can be used alone or in combination of two or more.

### 1-1-2. Polar Solvents

As the polar solvent, ester-based solvents, alcohol-based solvents, fatty acid-based solvents and ether-based solvents can be used. These can be used alone or in combination of two or more.

The ester-based solvent includes, for example, higher fatty acid esters having 5 or more, preferably 9 or more and more preferably 12 to 32 carbon atoms in one molecule. Examples thereof include isodecyl isononanoate, isotridecyl isononanoate, isononyl isononanoate, methyl laurate, isopropyl laurate, isopropyl myristate, isopropyl palmitate, isooctyl palmitate, hexyl palmitate, isostearyl palmitate, isooctyl isopalmitate, methyl oleate, ethyl oleate, isopropyl oleate, butyl oleate, hexyl oleate, methyl linoleate, isobutyl linoleate, ethyl linoleate, butyl stearate, hexyl stearate, isooctyl stearate, isopropyl isostearate, 2-octyldodecyl pivalate, soybean oil methyl ester, soybean oil isobutyl ester, tall oil methyl ester, tall oil isobutyl ester, diisopropyl adipate, diisopropyl sebacate, diethyl sebacate, propylene glycol monocaprate, trimethylolpropane tri-2-ethylhexanoate, and glyceryl tri-2-ethylhexanoate.

The alcohol-based solvent includes, for example, aliphatic higher alcohols having 12 or more carbon atoms in one molecule. Concrete examples thereof include higher alcohols such as isomyristyl alcohol, isopalmityl alcohol, isostearyl alcohol, and oleyl alcohol.

The fatty acid-based solvent includes, for example, fatty acids having 4 or more, preferably 9 to 22 carbon atoms in one molecule. Examples thereof include isononanoic acid, isomyristic, acid, hexadecanoic acid, isopalmitic acid, oleic acid, and isostearic acid.

The ether-based solvent includes, for example, glycol ethers such as diethylglycol monobutyl ether, ethyleneglycol monobutyl ether, propyleneglycol monobutyl ether and propyleneglycol dibutyl ether, and acetates of glycol ethers.

### 1-2. Coloring Materials

As the coloring material, any of pigments and dyes can be used, and may be used alone or in combination of both. It is preferable to use a pigment as a coloring material from the viewpoint of weatherability of prints.

The coloring material is contained preferably in an amount of 0.01 to 20 mass % based on the total amount of the oil-based ink.

### 1-2-1. Dyes

As the dye, dyes generally used in the technical field of printing can be used without any particular limitation. Examples thereof include oil-soluble dyes such as naphthol dyes, azo dyes, metal complex salt dyes, anthraquinone dyes, quinone imine dyes, indigo dyes, cyanine dyes, quinoline dyes, nitro dyes, nitroso dyes, benzoquinone dyes, carbonium dyes, naphthoquinone dyes, naphthalimide dyes, phthalocyanine dyes and perinine dyes. These dyes can be used alone or in combination of two or more.

### 1-2-2. Pigments

As the pigment, pigments generally used in the technical field of printing, including organic and inorganic pigments, can be used without any particular limitation. Examples thereof which can preferably be used include carbon black, cadmium red, chromium yellow, cadmium yellow, chromium oxide, viridian, titanium cobalt green, ultramarine blue, Prussian blue, cobalt blue, azo pigments, phthalocyanine pigments, quinacridone pigments, isoindolinone pigments, dioxadine pigments, threne pigments, perylene pigments, thioindigo pigments, quinophthalone pigments and metal complex pigments. These pigments may be used alone or in combination of two or more.

### 1-2-3. Pigment Dispersing Agents

It is preferable to add a pigment dispersing agent to the oil-based ink in order to make good dispersion of the pigment in the oil-based ink. The pigment dispersing agents used in the present invention are not particularly limited as long as they can stably disperse the pigment in a solvent. Examples thereof include a hydroxyl group-containing carboxylic acid ester, a salt of a long-chain polyaminoamide and a high-molecular weight acidic ester, a salt of a high molecular weight polycarboxylic acid, a salt of a long-chain polyaminoamide and a polar acidic ester, a high molecular weight unsaturated acidic ester, a high molecular weight copolymer, a modified polyurethane, a modified polyacrylate, a polyetherester type anionic surfactant, a naphthalene sulfonic acid formalin condensate salt, a polyoxyethylene alkylphosphoric acid ester, a polyoxyethylene nonylphenyl ether, a polyesterpolyamine, a stearylamine acetate and the like. Of these, high molecular weight dispersing agents are preferably used.

Concrete examples of the pigment dispersing agents include “SOLSPERSE 5000 (phthalocyanine ammonium salt based), 13940 (polyester amine based), 17000, 18000 (aliphatic amine based), 11200, 22000, 24000, and 28000” (all trade names) available from Lubrizol Japan Ltd.; “EFKA 400, 401, 402, 403, 450, 451, 453 (modified polyacrylate), 46, 47, 48, 49, 4010, 4055 (modified polyurethane)” (all trade names) available from Efka Chemicals; “DEMOL P, EP, POIZ 520, 521, 530, HOMOGENOL L-18 (polycarboxylate type polymer surfactants)” (all trade names) available from Kao Corporation; “DISPARLON KS-860, KS-873N4 (high molecular weight polyester amine salt)” (both trade names) available from Kusumoto Chemicals, Ltd.; and “DISCOL 202, 206, OA-202, OA-600 (multi-chain polymeric nonionic based)” (all trade names) available from Daiichi Kogyo Seiyaku Co., Ltd.

Of the above pigment dispersing agents, a polyamide-based dispersing agent that has a pectinated structure constituted by a plurality of side chains composed of polyester is preferably used. The polyamide-based dispersing agent that has a pectinated structure constituted by a plurality of side chains composed of polyester is a compound which has a main chain containing many nitrogen atoms such as polyethylene-imine and has a plurality of side chains that are bonded to the nitrogen atoms through amide-linkage in which the side chains are polyesters. Examples thereof include dispersing agents with a structure that has a main chain formed of polyalkyleneimine such as polyethyleneimine to which 3 to 80 poly(carbonyl-C₃₋₆-alkyleneoxy) chains are bonded as side chains through amide-linkage, as is disclosed in JP-A-H5-177123. The above SOLSPERSE 11200 and SOLSPERSE 28000 (all trade names) available from Lubrizol Japan Ltd. correspond to the polyamide-based dispersing agent having such a pectinated structure.

The pigment dispersing agents may be contained in an amount sufficient to disperse the pigment in the above organic solvents, and the amount can be set properly.

### 1-3. Other Components

In addition to the above organic solvent, coloring material and pigment dispersing agent, other components such as surfactants, fixing agents and antiseptics can be added to the oil-based ink of the present invention as long as they do not adversely affect the property of the ink.

### 1-4. Production Method of the Oil-Based Ink

The oil-based ink of the present invention can be prepared by putting the whole or part of the components in a known dispersing machine such as a beads mill to obtain a dispersion and if necessary passing it through a known filtering machine such as a membrane filter. For example, the oil-based ink can be prepared by previously mixing part of the solvent with the whole of the pigment uniformly and dispersing the mixture in a dispersing machine, and then adding the rest of the components to the resulting dispersion followed by filtration.

### 2. Coating Solution

The coating solution used in the present invention is mainly composed of inorganic particles, a vinyl chloride-based resin emulsion and water, and may contain other components, if required.

### 2-1. Inorganic Particles

As the inorganic particles, can be used inorganic particles used as an extender pigment, and examples thereof include inorganic particles such as of silica, calcium carbonate, barium sulfate, titanium oxide, zinc oxide, alumina white, aluminum hydroxide, white clay, talc, clay, diatomite, kaolin and mica. In addition, colloidal silica may be used. These inorganic particles are required to have an average particle diameter of not more than 15 μm and preferably not more than 13 μm. The average particle diameter can be measured according to laser diffraction scattering method by use of a laser diffraction particle size analyzer. For example, an average particle diameter of an inorganic particle dispersed in water can be measured by SALD-2000A manufactured by Shimadzu Corporation at 25° C. with a laser light of 680 nm in wavelength. When the average particle diameter is larger than 15 μm, the effect of filling the printing medium is insufficient, and the effect of improving printing density cannot be obtained sufficiently. The inorganic particles preferably have a specific gravity of 0.1-5.7.

The inorganic particles are contained in an amount of preferably 0.01-40 mass % and more preferably 5-30 mass % relative to the total amount of the coating solution.

### 2-2. Dispersion Agent for Inorganic Particles

The dispersing agent can be used to disperse the inorganic particles in the coating solution. The dispersing agent for the inorganic particles is not particularly limited. Examples of the dispersing agent that can be used include “DEMOL P, EP, POIZ 520, 521, 530, HOMOGENOL L-18 (polycarboxylate type polymer surfactants)” (all trade names) available from Kao Corporation, and “SHALLOL DC-303P and DC-902P” (quaternary ammonium salt type polymer surfactant) (both trade names) available from Dai-ichi Kogyo Seiyaku Co., Ltd.

### 2-3. Vinyl Chloride-Based Resin Emulsion

A vinyl chloride-based resin emulsion is contained in the coating solution, and thus drying time and film-forming time immediately after applying the coating solution onto paper can be shortened compared with a coating solution containing another resin, thereby inhibiting bleeding of ink and ink stain transferred by rollers after printing. The vinyl chloride-based resin is used in a form of emulsion because this makes it possible to have a more excellent effect of inhibiting ink stain transferred by rollers.

The vinyl chloride-based resin includes a homopolymer of vinyl chloride, and a copolymer comprising not less than 50 mass % of vinyl chloride with another monomer copolymerizable with the vinyl chloride. Another monomer copolymerizable with the vinyl chloride includes, for example, alkyl(meth)acrylates such as methyl(meth)acrylate, ethyl(meth)acrylate and octylacrylate, a-monoolefins such as ethylene and propylene, and vinyl acetate.

Particle diameter of the vinyl chloride-based resin in the vinyl chloride-based resin emulsion is not particularly limited, and if it is within an ordinary range, the same effect of inhibiting bleeding of ink and ink stain transferred by rollers after printing can be obtained. Also, glass transition temperature Tg and film-forming temperature MFT (° C.) of the vinyl chloride-based resin emulsion are not particularly limited, and within a wide range of Tg and MFT of the vinyl chloride-based resin emulsion, the same effect of inhibiting bleeding of ink and ink stain transferred by rollers after printing can be obtained.

Available vinyl chloride-based resin emulsions include “VINYBLAN 271, 278, 603, EML, 700, 701, 711, 721” (all trade names) available from Nissin Chemical Industry Co., Ltd.

The vinyl chloride-based resin emulsion is preferably contained in an amount of 2-80 mass % and more preferably 2-40 mass % as solid matter relative to the amount of inorganic particles.

The vinyl chloride-based resin emulsion can be used together with a water-soluble resin. Such a water-soluble resin includes, for example, a polyvinyl alcohol with a degree of polymerization of not more than 500 and a degree of saponification of not less than 60 mol % from the viewpoint of inhibition of ink stain transferred by rollers and improvement of printing density. The polyvinyl alcohol is not particularly limited as long as it has a degree of polymerization and a degree of saponification within the above ranges, and those available from various manufacturers can be used. A preferable polyvinyl alcohol is one which dissolves uniformly without granular appearance to become a clear liquid entirely, when it is added to and dissolved in water at 100° C. for 30 minutes under stirring. When the degree of polymerization exceeds 500, ink stain on rollers inside printing devices and on continuously printed printing paper is not sufficiently inhibited upon printing. Also, when the degree of saponification is less than 60 mol %, ink stain on rollers inside printing devices and on continuously printed printing paper is not sufficiently inhibited upon printing. The degree of polymerization is preferably 180-500 and more preferably 250-500. The degree of saponification is preferably not less than 65 mol %.

When a water-soluble resin is used together with a vinyl chloride-based resin emulsion, the water-soluble resin is preferably contained in 10-35 mass % relative to the amount of inorganic particles. When the water-soluble resin and the vinyl chloride-based resin emulsion are too much, printed dot size increases and bleeding occurs, and thus printing density and image quality are lowered. On the other hand, when the amount of the water-soluble resin and vinyl chloride-based resin emulsion is too small, the film coated on the paper is lowered in strength, and thus the coated layer becomes easy to peel off. Therefore, the total amount of the water-soluble resin and vinyl chloride-based resin emulsion is preferably 10-120 mass % and more preferably 30-60 mass % relative to the amount of inorganic particles. Also, the amount of the vinyl chloride-based resin emulsion is preferably 5-80 mass % and more preferably 10-40 mass % as a solid matter relative to the total amount of the water-soluble resin and vinyl chloride-based resin emulsion.

### 2-4. Water

Water of the coating solution used in the present invention is not particularly limited as long as it does not affect dispersibility of the inorganic particles and polyvinyl alcohol in the coating solution, and may be tap water, ion-exchanged water and the like.

### 2-5. Other Components

In addition to the above components, other components such as surfactants, fixing agents and antiseptics can be added to the coating solution used in the present invention as long as they do not adversely affect the property thereof.

### 2-6. Production Method of the Coating Solution

The coating solution used in the present invention can be prepared by putting the whole or part of the components in a known dispersing machine such as a beads mill to obtain a dispersion and if necessary passing it through a known filtering machine such as a membrane filter. A method in which polyvinyl alcohol is dissolved in water, and then a dispersing agent is dissolved therein, and lastly inorganic particles are added and stirred until it becomes uniform is suitable.

### 3. Printing Method

In the present invention, the printing method is not particularly limited as long as it is a printing method using an oil-based ink, and inkjet printing is suitable.

According to the present invention, the inkjet printing method is performed by applying a coating solution onto a printing medium, and then ejecting an oil-based ink on the printing medium. The application of the coating solution onto the printing medium can be performed by uniformly coating a surface of the printing medium using a brush, roller, bar coater, air knife coater or the like, or printing an image with printing means such as inkjet printing, gravure printing and flexiso printing. For example, printing may be performed by ejecting the coating solution onto a printing medium, and then successively ejecting the oil-based ink using the inkjet printer so as to overlay it on the coating solution that has been ejected onto the printing medium. Meanwhile, in the present invention, after the coating solution is applied onto the printing medium, the oil-based ink may be ejected before the applied coating solution is dried, or the oil-based ink may be ejected after the applied coating solution is dried.

The coating solution is applied preferably in an amount of 2.0-6.0 g/m². As the amount of the coating solution applied onto printing paper increases, the amount (g/m²) of the inorganic particles in the coated layer increases proportionally. When the amount (g/m²) of the inorganic particles is too much, bleeding of printed dots becomes too small so that when printing is performed at a resolution of 300×300 dpi or the like, a printed dot size sufficient for forming solid image cannot be obtained, and thus, prints with high density cannot be obtained although strike through is inhibited.

It is advantageous to constitute and market an ink set comprising at least an above-mentioned coating solution and an oil-based ink in order to make it easier to carry out the printing method, particularly the inkjet printing method according to the present invention.

In the present invention, the printing medium is not particularly limited, and may be plain paper, glossy paper, specialty paper, fabrics, films, OHP sheets, and the like. Especially, according to the present invention, even when printing is performed on plain paper, coloring materials stay on the surface of printing paper without permeating through the printing paper, and thus great advantages result including improvement of printing density and decrease in strike through and bleeding as well as prevention of ink stain on rollers inside printing devices and on continuously printed printing paper.

### EXAMPLE

Hereinafter, the present invention will be described in detail by way of Examples and Comparative Examples, however, the present invention is not limited to these examples.

### Production Example 1

### Preparation of the Coating Solution

The components shown in Table 1 were premixed in the ratio shown in Table 1, and then the mixture was dispersed in an ultrasonic disperser for 1 minute. The resulting dispersion was used as a coating solution.

TABLE 1
Composition of coating solution (mass %)

| | | Name | CS* 1 | CS 2 | CS 3 | CS 4 | CS 5 | CS 6 | CS 7 | CS 8 | CS 9 |
|---|---|---|---|---|---|---|---|---|---|---|---|
| Silica | Gel type | MIZUKASIL P-73 | 4.5 | 4.5 | 4.5 | 4.5 | 4.5 | 4.5 | 4.5 | 4.5 | 4.5 |
| particles | Gel type | MIZUKASIL P-758C | 10.5 | 10.5 | 10.5 | 10.5 | 10.5 | 10.5 | 10.5 | 10.5 | 10.5 |
| Dispersing agent | | DEMOL EP | 4.0 | 4.0 | 4.0 | 4.0 | 4.0 | 4.0 | 4.0 | 4.0 | 4.0 |
| Water | PVA | JMR-10M | 5.0 | 5.0 | 5.0 | 5.0 | 5.0 | 5.0 | 5.0 | 5.0 | 5.0 |
| soluble | | | | | | | | | | | |
| resin | | | | | | | | | | | |
| Water- | Styrene/Acryl | Mowinyl 966A | 3.33 | | | | | | | | |
| based | Acryl | Mowinyl 7320 | | 3.75 | | | | | | | |
| resin | Vinyl acetate | Mowinyl 384 | | | 2.73 | | | | | | |
| emulsion | based | | | | | | | | | | |
| | Acryl | Mowinyl 735 | | | | | | | | | |
| | Water | VYLONAL MD-1100 | | | | 5.00 | | | | | |
| | dispersed | VYLONAL MD-1480 | | | | | 6.00 | | | | |
| | polyester | | | | | | | | | | |
| | Vinyl chloride- | VINYBLAN 278 | | | | | | 3.49 | | | |
| | based | VINYBLAN 603 | | | | | | | 3.00 | | |
| | | VINYBLAN EML | | | | | | | | | |
| | | VINYBLAN 271 | | | | | | | | | |
| | Urethane | SUPERFLEX 150 | | | | | | | | 5.00 | |
| | based | SUPERFLEX 170 | | | | | | | | | 4.55 |
| | | SUPERFLEX 300 | | | | | | | | | |

| | | | | | | | | | | |
|---|---|---|---|---|---|---|---|---|---|---|
| Polyvinyl chloride resin | Polyvinyl chloride | | | | | | | | | |
| Antiseptic agent | Surauto 33 | 0.01 | 0.01 | 0.01 | 0.01 | 0.01 | 0.01 | 0.01 | 0.01 | 0.01 |
| Deforming agent | SURFYNOL DF-58 | 0.02 | 0.02 | 0.02 | 0.02 | 0.02 | 0.02 | 0.02 | 0.02 | 0.02 |
| Solvent | Ion exchanged water | 72.6 | 72.2 | 73.2 | 71.0 | 70.0 | 72.5 | 73.0 | 71.0 | 71.4 |

| | | | | | | | | | |
|---|---|---|---|---|---|---|---|---|---|
| Total | 100.0 | 100.0 | 100.0 | 100.0 | 100.0 | 100.0 | 100.0 | 100.0 | 100.0 |

| | | Name | CS 10 | CS 11 | CS 12 | CS 13 | CS 14 | CS 15 | CS 16 | CS 17 |
|---|---|---|---|---|---|---|---|---|---|---|
| Silica | Gel type | MIZUKASIL P-73 | 4.5 | 4.5 | 4.5 | 4.5 | 4.5 | 4.5 | 4.5 | 4.5 |
| particles | Gel type | MIZUKASIL P-758C | 10.5 | 10.5 | 10.5 | 10.5 | 10.5 | 10.5 | 10.5 | 10.5 |
| Dispersing agent | | DEMOL EP | 4.0 | 4.0 | 4.0 | 4.0 | 4.0 | 4.0 | 4.0 | 4.0 |
| Water | PVA | JMR-10M | 5.0 | 5.0 | 5.0 | 5.0 | 5.0 | 5.0 | 5.0 | 5.0 |
| soluble | | | | | | | | | | |
| resin | | | | | | | | | | |
| Water- | Styrene/Acryl | Mowinyl 966A | | | | | | | | |
| based | Acryl | Mowinyl 7320 | | | | | | | | |
| resin | Vinyl acetate | Mowinyl 384 | | | | | | | | |
| emulsion | based | | | | | | | | | |
| | Acryl | Mowinyl 735 | | 3.49 | | | | | | |
| | Water | VYLONAL MD-1100 | | | | | | | | |
| | dispersed | VYLONAL MD-1480 | | | | | | | | |
| | polyester | | | | | | | | | |
| | Vinyl chloride- | VINYBLAN 278 | | | | | | | | |
| | based | VINYBLAN 603 | | | | | | | | |
| | | VINYBLAN EML | | | | 3.00 | | | | |
| | | VINYBLAN 271 | | | | | 3.49 | 1.40 | 2.33 | 6.98 |
| | Urethane | SUPERFLEX 150 | | | | | | | | |
| | based | SUPERFLEX 170 | | | | | | | | |
| | | SUPERFLEX 300 | 5.00 | | | | | | | |

| | | | | | | | | | |
|---|---|---|---|---|---|---|---|---|---|
| Polyvinyl chloride resin | Polyvinyl chloride | | | 1.50 | | | | | |
| Antiseptic agent | Surauto 33 | 0.01 | 0.01 | 0.01 | 0.01 | 0.01 | 0.01 | 0.01 | 0.01 |
| Deforming agent | SURFYNOL DF-58 | 0.02 | 0.02 | 0.02 | 0.02 | 0.02 | 0.02 | 0.02 | 0.02 |
| Solvent | Ion exchanged water | 71.0 | 72.5 | 74.5 | 73.0 | 72.5 | 74.6 | 73.6 | 69.0 |

| | | | | | | | | |
|---|---|---|---|---|---|---|---|---|
| Total | 100.0 | 100.0 | 100.0 | 100.0 | 100.0 | 100.0 | 100.0 | 100.0 |

*CS is an abbreviation for coating solution.

Details of the materials shown in Table 1 mean as follows.
MIZUKASIL P-73: “MIZUKASIL P-73 (trade name)” (silica particles) available from MIZUSAWA INDUSTRIAL CHEMICALS, LTD.
MIZUKASIL P-758C: “MIZUKASIL P-758C (trade name)” (silica particles) available from MIZUSAWA INDUSTRIAL CHEMICALS, LTD.
DEMOL EP: “DEMOL EP (trade name)” (special polycarboxylate type polymer surfactant) available from Kao Corporation.
JMR-10M: “JMR-10M (trade name)” (degree of polymerization of 250 and degree of saponification of 65.0 mol %) available from JAPAN VAM & POVAL CO., LTD.
Mowinyl 966A: Water-based styrene/acryl resin emulsion available from The Nippon Synthetic Chemical Industry Co., Ltd.
Mowinyl 7320: Water-based acryl resin emulsion available from The Nippon Synthetic Chemical Industry Co., Ltd.
Mowinyl 384: Water-based vinyl acetate resin emulsion available from The Nippon Synthetic Chemical Industry Co., Ltd.
Mowinyl 735: Water-based acryl resin emulsion available from The Nippon Synthetic Chemical Industry Co., Ltd.
VYLONAL MD-1100: Water dispersed polyester resin available from TOYOBO CO., LTD.
VYLONAL MD
., LTD.
VINYBLAN 278: Water-based vinyl chloride-based resin emulsion available from Nissin Chemical Industry Co., Ltd.
VINYBLAN 603: Water-based vinyl chloride-based resin emulsion available from Nissin Chemical Industry Co., Ltd.
VINYBLAN EML: Water-based vinyl chloride-based resin emulsion available from Nissin Chemical Industry Co., Ltd.
VINYBLAN 271: Water-based vinyl chloride-based resin emulsion available from Nissin Chemical Industry Co., Ltd.
SUPERFLEX 150: Water-based urethane resin emulsion available from Dai-ichi Kogyo Seiyaku Co. Ltd.
SUPERFLEX 170: Water-based urethane resin emulsion available from Dai-ichi Kogyo Seiyaku Co. Ltd.
SUPERFLEX 300: Water-based urethane resin emulsion available from Dai-ichi Kogyo Seiyaku Co. Ltd.
Polyvinyl chloride: Water-soluble polyvinyl chloride resin available from Wako Pure Chemical Industries, Ltd.
Surauto 33: Antiseptics available from Japan EnviroChemicals, Ltd.
SURFYNOL DF-58: Silicone-modified deforming agent available from Nissin Chemical Industry Co., Ltd.

Among the above, properties of each material except the antiseptics and deforming agent are shown in Table 2.

TABLE 2
(a) Silica particles

| | | Average | Amount of oil | Specific | |
|---|---|---|---|---|---|
| | | particle | absorption | surface area | AOA/SSA* |
| | Trade name | diameter (μm) | (ml/100 g) | (m²/g) | (×10⁻² ml/g) |
| Gel type | MIZUKASIL P-73 | 4 | 180 | 330 | 0.55 |
| Gel type | MIZUKASIL P-758C | 13 | 134 | 530 | 0.25 |

*AOA/SSA is an abbreviation for amount of oil absorption/specific surface area.

(b) Dispersing agent

| | Solid matter |
|---|---|
| Trade name | (mass %) |
| DEMOL EP | 25 |

(c) Water soluble resin

| | | | Degree of | |
|---|---|---|---|---|
| | | Degree of | saponification | Solid matter |
| | Trade name | polymerization | (mol %) | (mass %) |
| PVA | JMR-10M | 250 | 65.0 | 100 |

(d) Water-based resin emulsion

| | | | Glass | | |
|---|---|---|---|---|---|
| | | | transition | Film forming | |
| | | Degree of | temperature Tg | temperature | Solid matter |
| | Trade name | polymerization | (C. °) | MFT (C. °) | (mass %) |
| Styrene/Acryl | Mowinyl 966A | | −32 | 0 | 45 |
| Acryl | Mowinyl 7320 | | −20 | 0 | 40 |
| Vinyl | Mowinyl 384 | | 30 | 0 | 55 |
| acetate | | | | | |
| based | | | | | |
| Acryl | Mowinyl 735 | | 14 | 25 | 43 |
| Water | VYLONAL MD-1100 | | 40 | | 30 |
| dispersed | VYLONAL MD-1480 | | 20 | | 25 |
| polyester | | | | | |
| Vinyl | VINYBLAN 278 | 180 | 30 | 50 | 43 |
| chloride- | VINYBLAN 603 | 150 | 60 | 60 | 50 |
| based | VINYBLAN EML | 150 | 15 | 0 | 50 |
| | VINYBLAN 271 | 230 | −3 | 0 | 43 |
| Urethane | SUPERFLEX 150 | | 40 | 5≧ | 30 |
| based | SUPERFLEX 170 | | 0 | 5≧ | 33 |
| | SUPERFLEX 300 | | −42 | 5≧ | 30 |

(e) Polyvinyl chloride resin

| | Solid matter |
|---|---|
| Trade name | (mass %) |
| Polyvinyl chloride | 100 |

### Production Example 2

### Preparation of the Oil-Based Ink

The components shown in Table 3 were premixed in the ratio shown in Table 3, and then the mixture was dispersed for 60 minutes in a Rocking Mill (manufactured by Seiwa Giken Co., Ltd.) in which zirconium beads having a diameter (φ) of 0.5 mm were placed. The resulting dispersion was filtered with a membrane filter (having pores of 3 μm in diameter) to obtain a black oil-based ink 1.

TABLE 3
Composition of oil-based ink (mass %)

| | | Ink 1 |
|---|---|---|
| Pigment | Carbon black | 8 |
| Dispersing agent | SOLSPERSE 28000 | 2 |
| Organic solvent | Methyl oleate | 30 |
| | Isopropyl myristate | 30 |
| | Hydrocarbon solvent | 30 |

| | |
|---|---|
| Total | 100 |

MA-11: “MA-11 (trade name)” (carbon black) available from Mitsubishi Chemical Corporation.
SOLSPERSE 28000: “SOLSPERSE 28000 (trade name)” (a pigment dispersing agent) available from Lubrizol Japan Ltd.
EXCEPARL M-OL: “EXCEPARL M-OL (trade name)” (methyl oleate) available from Kao Corporation.
EXCEPARL IPM: “EXCEPARL IPM (trade name)” (isopropyl myristate) available from Kao Corporation.
NORMAL PARAFFIN H: “NORMAL PARAFFIN H (trade name)” (hydrocarbon solvent) available from JX Nippon Oil & Energy Corporation.

### Examples 1-7 and Comparative Examples 1-11

The oil-based ink shown in Table 3 was introduced into the ejection route of the inkjet printer “ORPHIS HC5500 (trade name)” manufactured by RISO KAGAKU CORPORATION.

Using plain paper “RISO-YOSHI, USUKUCHI (trade name)” manufactured by RISO KAGAKU CORPORATION as printing paper, the coating solution shown in Table 1 was coated on an entire surface on one side of the printing paper with an automatic bar coater so that the amount of silica particles in the coating layer after drying was 2.69 g/m². 30 seconds or 60 seconds after coating, the oil-based ink was ejected onto the treated surface of the printing paper to print solid image. Printing was carried out with the resolution of 300×300 dpi. The resulting prints were evaluated in accordance with the following standards. The results are shown in Tables 4 and 5. Meanwhile, since the ink amount per one dot when solid image is printed was changed in every evaluation item, it will be described later in the description of each evaluation item.

### Printing Density of Prints

Printing of solid image was carried out with the ink amount of 36 pL/dot. The resulting print was left to stand at 23° C. and 50% R.H. overnight, and then printing density (OD value) on the surface of the solid image was measured with an optical densitometer (RD920; manufactured by Macbeth) and evaluated in accordance with the following standards.
Evaluation standards when printing timing was set to 30 seconds after coating:
A: OD value is not less than 1.25
B: OD value is not less than 1.20 and less than 1.25
C: OD value is less than 1.20
Evaluation standards when printing timing was set to 60 seconds after coating:
A: OD value is not less than 1.30
B: OD value is not less than 1.25 and less than 1.30
C: OD value is less than 1.25
   Ink stain transferred by rollers

Printing of solid image was carried out with the ink amount of 42 pL/dot. The resulting print was passed through NBR rollers immediately after printing, and degree of ink stain transferred by the rollers onto the surface of the print in the passing direction was visually observed and evaluated based on the following evaluation standards.

Evaluation standards when printing timing was set to 30 seconds and 60 seconds after applying the coating solution:
A: no ink stain is found.
B: ink stain lighter than printing image is found
C: printing image is transferred darkly as it is.

TABLE 4

| | | Example 1 | Example 2 | Example 3 | Example 4 | Example 5 | Example 6 | Example 7 |
|---|---|---|---|---|---|---|---|---|
| Evaluation item | Printing - | CS* 6 | CS 7 | CS 13 | CS 14 | CS 15 | CS 16 | CS 17 |
| | Evaluation timing | | | | | | | |
| Printing density | 30 sec after coating | A | A | A | A | A | A | A |
| | 60 sec after coating | A | A | A | A | A | A | A |
| Ink stain transferred | 30 sec after coating | A | A | A | A | A | A | A |
| by rollers | 60 sec after coating | A | A | A | A | A | A | A |

*CS is an abbreviation for coating solution

The followings are found from the results of Table 4.

In Examples 1-7 in which the coating solution of the present invention was used, when printing timing was set to 30 seconds and 60 seconds after applying the coating solution, the ink stain transferred by rollers was inhibited while sufficient printing density was obtained.

TABLE 5

| | | Comp. | Comp. | Comp. | Comp. | | | | | | Comp. | Comp. |
|---|---|---|---|---|---|---|---|---|---|---|---|---|
| | | Exam- | Exam- | Exam- | Exam- | Comp. | Comp. | Comp. | Comp. | Comp. | Exam- | Exam- |
| | | ple 1 | ple 2 | ple 3 | ple 4 | Example 5 | Example 6 | Example 7 | Example 8 | Example 9 | ple 10 | ple 11 |
| Evaluation | Printing - | UUP*¹ | CS*² 1 | CS 2 | CS 3 | CS 4 | CS 5 | CS 8 | CS 9 | CS 10 | CS 11 | CS 12 |
| item | Evaluation timing | | | | | | | | | | | |
| Printing | 30 sec after coating | C | B | B | B | A | C | B | B | C | B | B |
| density | 60 sec after coating | C | B | B | C | C | C | B | C | C | B | B |
| Ink stain | 30 sec after coating | A | C | B | C | B | C | B | B | C | B | C |
| transferred | 60 sec after coating | A | A | A | C | B | C | C | C | C | A | C |
| by rollers | | | | | | | | | | | | |

*¹UUP is an abbreviation for untreated “usukuchi” printing paper.
*²CS is an abbreviation for coating solution.

In contrast, the followings are found from the results of Comparative Examples in Table 5. In Comparative Example 1 in which the coating solution of the present invention was not used, printing density was low. Also, in Comparative Examples 2-10 in which a coating solution which contains another kind of resin such as styrene/acryl based resin and acryl resin than the vinyl chloride-based resin emulsion was used, at least one of the cases of printing timing 30 seconds and 60 seconds after applying the coating solution was insufficient in printing density or ink stain transferred by rollers. Further, in Comparative Example 11 in which a coating solution which contained a vinyl chloride resin that was not in the form of emulsion was used, printing density was low and ink stain transferred by rollers also occurred.

The inkjet printing method and the ink set according to the present invention can be easily practiced by an inkjet printer in which a printing medium is surface-treated with a coating solution, and then an oil-based ink is ejected from a nozzle head to print on the treated surface of the printing medium, and thus can be utilized widely in the field of inkjet printing.

1. A printing method using an oil-based ink, which comprises applying a coating solution onto a printing medium and then performing printing on the printing medium with an oil-based ink that comprises at least a coloring material and a solvent, in which said coating solution comprises at least inorganic particles, a vinyl chloride-based resin emulsion and water.

2. The printing method according to claim 1, wherein said inorganic particles are silica.

3. The printing method according to claim 1, wherein said coating solution is applied in an amount of 2.0-6.0 g/m² as an amount of inorganic particles.

4. An ink set for applying a coating solution onto a printing medium and then performing printing on the printing medium with an oil-based ink, which comprises an oil-based ink comprising at least a coloring material and a solvent, and a coating solution comprising at least inorganic particles, a vinyl chloride-based resin emulsion and water.

5. A coating solution for printing with an oil-based ink, which comprises at least inorganic particles, a vinyl chloride-based resin emulsion and water.
